(19) United States
(12) Patent Application Publication
(10) Pub. No.: US 2004/0250880 A1
(43) Pub. Date: Dec. 16, 2004

(54) Hinge mortise tool

(76) Inventor: Mark Dement, Richmond Hill, GA (US)

Correspondence Address: John B. Hardaway, III, NEXSEN PRUET JACOBS & POLLARD, LLC, Fed. Sta., P.O. Box 10107, Greenville, SC, 29603-0107, US

(21) Appl. No.: 10/436,447

(22) Filed: May 12, 2003

Related U.S. Application Data
(60) Provisional application No. 60/415,201, filed on May 10, 2002.

(51) Int. Cl. B27F 5/00

(52) U.S. Cl. 144/82

(57) ABSTRACT

A guide for the formation of mortis joints using a spiral rotary cutter provides a first guide portion having faces at 90° and bisected by more than one half of its surface by a groove and a means for fastening this guide to the base of a rotary cutting tool.

Benefit is claimed of provisional patent application 60/415,201, filed 10 May 2002.

### FIELD OF THE INVENTION

This invention is directed to an adaptor which quickly converts a spiral saw or cut-out tool into an efficient mortising tool for the installation of mortise hinges in cabinets or other furniture.

### BACKGROUND AND PRIOR ART

Proper operation of cabinet hinges require that one or both of the hinge leaves be mounted flush to the surface of the cabinet frame and/or door. Through the history of cabinetry many methods have been employed to create the shallow mortise which is necessary for hinge installation. Prior to the availability of power tools, this mortising was often done using chisels. The availability of electric routers produced numerous arrangements to use the router for mortising. Typically these devices are clamped or otherwise mounted onto the work piece. U.S. Pat. No. 4,031,391 to Balcombe, U.S. Pat. No. 4,197,887 to Groves, U.S. Pat. No. 5,067,537 to Offner, U.S. Pat. No. 5,511,312 to Hobbs, and U.S. Pat. No. 5,524,684 to Stuckel are representative of various clamping and guide systems which have been developed. These devices and systems are suitable for passage doors and similar large scale woodworking but are inconvenient for use with doors and frames for furniture, kitchen cabinets and other light construction which requires a comparatively small and shallow mortis for the installation of these hinges.

### BRIEF DESCRIPTION OF THE INVENTION

It is an object of this invention to provide a tool for cutting or enlarging mortises in cabinetry which does not require clamping or other jigs to form the mortise. It is a further object of this invention to provide a tool which is readily adaptable to existing rotary saws without requiring any changes in the saws and attachments usually provided. It is a further objective of this invention to provide a single mortising tool which can be adjusted to cut hinged mortises of different thickness and depth.

These and other objects of the invention are achieved by the use of an angled guide which limits movement of the mortising tool in two dimensions while allowing the cut to be made in the direction of the third dimension. The mortising guide attaches to a spiral rotary cut-out saw through a flat plate fitted to the standard circular guide, normally available as standard equipment or an option to rotary cut-out saws.

### BRIEF DESCRIPTION OF THE DRAWINGS

FIG. 1 shows the mortise guide device mounted on a base of a spiral rotary cutter.

FIG. 2 shows the device of FIG. 1 when viewed from the opposite side.

FIG. 3. shows the individual components of the mortise cutting device.

FIG. 4 shows the mortise cutting device mounted on a typical rotary cutter.

### DETAILED DESCRIPTION OF THE INVENTION

The cutter guide of this invention is used to control a spiral cutter in depth and width when cutting mortises for mortised cabinet hinges. The apparatus allows the hinged mortises to be cut after a cabinet has been constructed and is also useful for increasing the size of the mortise when different hinges having a larger leaves are installed. The mortise cutter using the described guide operates without the need of special templates which are conventionally affixed to surface to be mortised. In addition, it is possible to cut mortises closer to the top and bottom of a cabinet and in the vicinity of fixed shelving, two locations which are difficult or impossible to mortise using a conventional router with its large base plate.

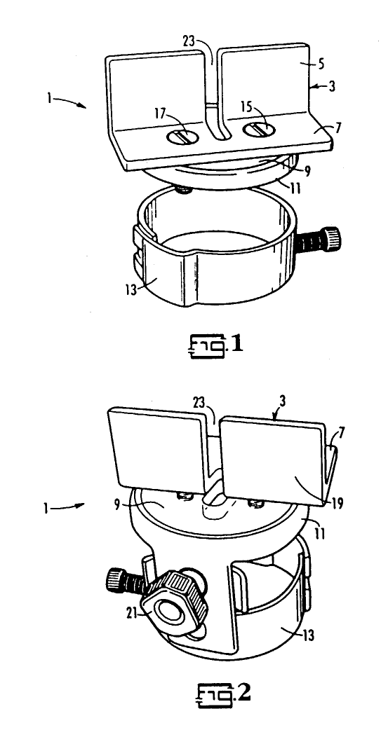

As shown in FIG. 1, the guide device 1 consists of a guide plate 3 having a 90 degree angle, having a depth face 5 and a surface face 7. A backing plate 9 on the opposite side of tool flange 11 holds guide 3 in place by means of fasteners 15 and 17. Also shown is a tool mounting bracket 13 used to mount the guide to a spiral rotary cutting tool.

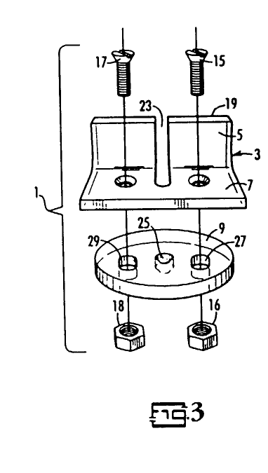

FIG. 2 shows the device of FIG. 1 viewed from the back and shows the back face 19, a conventional depth adjustment which is normally supplied with the tool and as an aftermarket device and also shows slot 23 which is cut into the depth face of the guide and extends partially into the surface face.

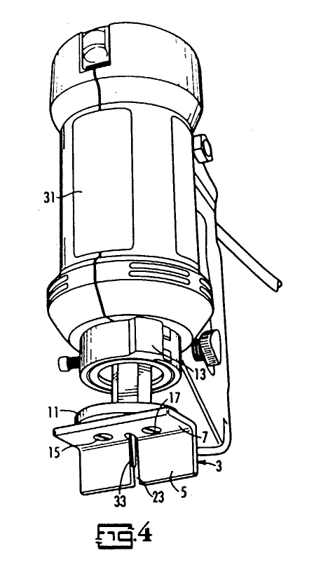

FIG. 3 shows the components of the invention in a disassembled state and shows fasteners 15 and 17 together with, in this example, nuts 16 and 18. It is noted that fasteners 15 and 17 are preferably beveled screws which fit into countersunk bores in guide 3. The backing plate 9 has a center hole 25 through which the rotary cutter blade passes and adjustable slots 27 and 29 through which fasteners 15 and 17 pass. The relationship of the cutter blade to the depth face 5 can be adjusted by sliding the guide 3 relative to the backing plate 9.

Alternatively, one of 15 and 17 may be fixed and one of slots 27, formed arcuately so that adjustment is achieved pivotally.

FIG. 4 shows a device mounted on a rotary cutter having a tool motor housing 31 and illustrates the location of the spiral cutting bit 33.

In operation, the device is mounted on the tool flange 11 and the depth of cut is adjusted using the thickness of the hinge leaf as a guide. When the correct depth has been established the fasteners are tightened. Then the depth in the horizontal direction or width of the hinge leaf is set using the adjustment shown as 21 on the tool adaptor to raise or lower bracket 13.

To cut a mortise, the hinge leaf, or a template for the hinged leaf is placed over the desired location and the edges scribed using a pencil or sharp blade. After adjusting the tool as described above, the guide is placed on the surface at or between the scribed lines. The motor is turned on and the mortise is cut.

The materials from which the mortise cutting guide is formed are not limiting. Any material which can be readily machined is suitable. Aluminum angle or extruded engineering plastics such as polyethylene or high-density polypropylene are preferred for guide 3. Backing plate 9 likewise may be formed from aluminum or plastic. In general, any hard metal is suitable for any of the components and the choice is not critical.

Changes and departures in this invention may be made by those skilled in the art without departing from the spirit and scope thereof. Therefore, the invention is not intended to be limited by the description and figures but are those as set forth in the following claims.

I claim:

1. A guide forming a hinged mortise using a spiral rotary cutter comprising:
(A) fabricated plate having two surfaces at 90° to each other, said plate having formed therein a groove dividing at least one surface into two halves and further dividing at least a portion of said second face;
(B) a backing plate;
(C) means for fastening said bracket to said backing plate at at least two points.

2. A guide according to claim 1 wherein said means for fastening said bracket to said backing plate allows adjustment of the bracket relative to said backing plate.
